(19) United States
(12) Patent Application Publication
(10) Pub. No.: US 2005/0287280 A1
(43) Pub. Date: Dec. 29, 2005

(54) Induction heating of product tube method and apparatus

(75) Inventors: Curt Hagen, Delavan, WI (US); Drew Van Norman, Whitewater, WI (US)

Correspondence Address: BAKER & HOSTETLER LLP;Washington Square, Suite 1100, 1050 Connecticut Avenue, N.W., Washington, DC, 20036, US

(73) Assignee: United Dominion Industries, Inc.

(21) Appl. No.: 10/874,194

(22) Filed: Jun. 24, 2004

(51) Int. Cl. A23L 1/32

(52) U.S. Cl. 426/615

(57) ABSTRACT

A method and apparatus for heating products in a scraped surface heat is provided for heating products supplied to and within a treatment chamber or product tube. Heat is provided through induction from an induction blanket configured around the product tube.

### FIELD OF THE INVENTION

The present invention relates generally to scraped surface heat exchangers. More particularly, the present invention relates to a method and apparatus for heating product tubes in scraped surface heat exchanger assemblies.

### BACKGROUND OF THE INVENTION

Scraped-surface heat exchangers are commonly utilized in aseptic processing of foodstuffs. These heat exchangers are preferred because of their capability to process heat-sensitive, viscous products, and minimize the extent of burn-on, or fouling on the heat transfer surface. Such heat exchangers are commonly marketed under the trade names, for example, Votator®, Thermutator®, Contherm®, and Terlotherm®. Waukesha Cherry-Burrell, Delavan, Wis., for example, manufactures such heat exchangers.

Scraped surface heat exchangers are particularly suitable for use in the foodstuff industry where they are used for heat treating products such as jellies, jams, peanut butter, sauces and puddings. A heat exchanger of this type may include a cylindrical treatment chamber or product tube and a rotor, also referred to as a mutator shaft, arranged in the chamber. A number of blade rows including a number of successively arranged blade scrapers may also be mounted on the rotor so as to make the blades scrape the inner surface of the chamber or product tube during operation.

The product for receiving heat treatment is generally introduced, in some embodiments, under pressure at one end of the heat exchanger and is generally designed to leave the heat exchanger at its opposite end. The product may generally be designed to flow between an outer surface of the mutator shaft and an inner surface of the product tube as it traverses a length of the scraped surface heat exchanger assembly. In a general design of the scraped surface heat exchanger assembly, the inside of a product tube is preferably scraped with blades mounted on the rotor or mutator shaft which rotates within the product tube. Additionally, the product tubes, along with the mutator shafts, may be manufactured with different lengths to provide various heat exchange areas. Furthermore, these scraped surface heat exchanger assemblies can be installed and operated in either a horizontal or vertical position.

In the heated foodstuff industry, scraped surface heat exchanger assemblies have been typically configured such that a heating medium, e.g., hot water or steam, to provide heat exchange to the product tube in order to heat a treated product. In some embodiments, the heating medium may be generally circulated on the outside of the treatment chamber or product tube in order to provide the heat exchange. Thus, a treatment chamber or product tube is typically heated so that a treated product will undergo a change of temperature as it passes through the scraped surface heat exchanger. The scraping of the product off the inner surface of the chamber during its passage through the heat exchanger, e.g., via the successively arranged blade scrapers mounted on the rotor can, thereby provide a considerably improved heat transmission.

Scraped surface heat exchanger assemblies utilizing heating mediums are typically retrofitted with media connections and additional equipment for performing numerous operations. Such equipment may include piping equipment for delivering the medium to the scraped surface heat exchanger, transferring heat to the product tube, means for transporting the medium away from the scraped surface heat exchanger, boiler equipment for reheating the medium, and additional piping equipment for returning the reheated medium back to the scraped surface heat exchanger for subsequent heating/heat transfer operations.

While the aforementioned designed can provide a certain level of heat transfer to treated products within scraped surface heat exchanger assemblies, numerous difficulties can be attributed to the use thereof. For example, the retrofitted equipment such as the piping equipment utilized to deliver the medium to, from and across the product tube, the boiler plant to reheat the medium, and additional piping equipment to return the reheated medium back to the scraped surface heat exchanger can be expensive to built, operate and maintain. Additionally, due to a possibility for crushing an external surface of the product tube as a result of the media operating under high temporal and pressure constraints, e.g., 250 psi, a heavy walled media jacket is generally required in order to meet ASME code/pressure requirements. Furthermore, the equipment set-up of the aforementioned design typically requires a product tube conducive to high heat transfer efficiency rates in preferred embodiments in order to provide sufficient heat transfer to a treated product. Such product tubes may preferably comprise materials including, for example, Nickel which can provide good heat transfer capabilities and strong corrosive resistant properties. However, a drawback to using product tubes comprising Nickel may include its fairly high expense.

Accordingly, it is desirable to provide a method and apparatus for heating products in a scraped surface heat exchanger that is cost effective, for instance, by reducing requirements for equipment set-up, maintenance, and operating costs. It is further desirable to provide a method and apparatus for heating products in a scraped surface heat exchanger which reduces a possibility for external crushing pressures on the product tube while providing sufficient, and in some cases, improved heat transfer to the product tube for heat treating products.

### SUMMARY OF THE INVENTION

The foregoing needs are met, to a great extent, by the present invention, wherein in one aspect a method and apparatus is provided that in some embodiments heats products in a scraped surface heat exchanger by induction heating.

In accordance with one aspect of the present invention, a scraped surface heat exchanger assembly is provided that, in some embodiments, includes a product tube, a mutator shaft, an induction blanket, a product feed inlet and a product return outlet.

In accordance with another aspect of the present invention, a method of heating products in a scraped surface heat exchanger assembly is provided, that in some embodiments, includes providing a product tube and assembling a mutator shaft within the inner surface of the product tube. The method may further include feeding a product through the product tube and heating the product via an induction blanket disposed around a longitudinal length of the product tube.

In accordance with yet another aspect of the present invention, a system for heating products in a scraped surface heat exchanger assembly is provided that in some embodiments, includes a means for containing a product, a means for rotating a product, a means for providing heat via induction, and a means for feeding a product.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a side view illustrating a mutator shaft for use with a scraped surface heat exchanger assembly according to a preferred embodiment of the invention.

FIG. 2 is an end view of one end of the mutator shaft shown in FIG. 1.

FIG. 3 is a side view illustrating the scraped surface heat exchanger assembly according to a preferred embodiment of the invention.

FIG. 4 is a cross-section view of the scraped surface heat exchanger assembly taken along A-A of FIG. 3.

### DETAILED DESCRIPTION

An embodiment in accordance with the present invention provides a method and apparatus for providing induction heating to a product tube of the type preferably utilized within scraped surface heat exchanger assembly. Preferred embodiments of the invention will now be described with reference to the drawing figures, in which like reference numerals refer to like parts throughout.

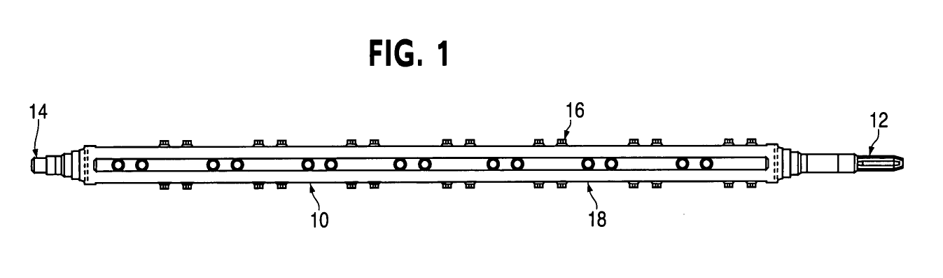

An embodiment of the present inventive method and apparatus is illustrated in FIG. 1, wherein a mutator shaft 10 for use with a scraped surface heat exchanger assembly 20 is shown. The mutator shaft 10 may be comprised of stainless steel material such as 316-L stainless steel. Such material is conducive to providing a sanitary working environment particularly suitable for use in the foodstuff industry. Additional construction of the mutator shaft 10 may include a drive mechanism such as splines 12 located at one end of the mutator shaft 10 and a roller bearing element 14 at the other end thereof. In a preferred embodiment, the splines 12 serve to facilitate rotation of the mutator shaft 10 through direct connection with a drive gear assembly 22 of a scraped surface heat exchanger assembly 20. The drive gear assembly 22 can be driven, for instance, by a motor 24 of the scraped surface heat exchanger assembly 20 in direct connection thereof.

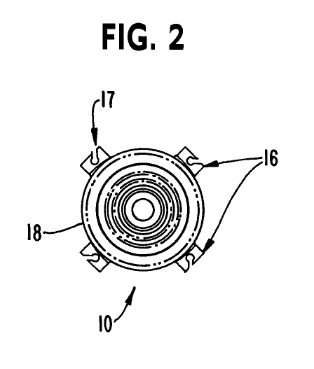

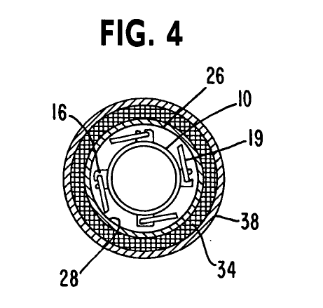

A plurality of scraper blade mounting pins 16 are preferably located on an outer surface 18 of the mutator shaft 10. The scraper blade mounting pins 16 are preferably welded to the outer surface 18 of the mutator shaft 10. In a preferred design, the scraper blade mounting pins 16 hold and retain inserted scraper blades 19 as provided, for example, by slots 17 shown in FIGS. 2 and 4. Thus, in a preferred configuration, as the mutator shaft 10 rotates, the scraper blade mounting pins 16 operate to receive and push inserted scraper blades to scrape a product off an inner surface of the chamber or product tube as a product traverses through the scraped surface heat exchanger assembly. The aforementioned assembly and method of scraping can provide a considerably improved heat transmission within the scraped surface heat exchanger assembly.

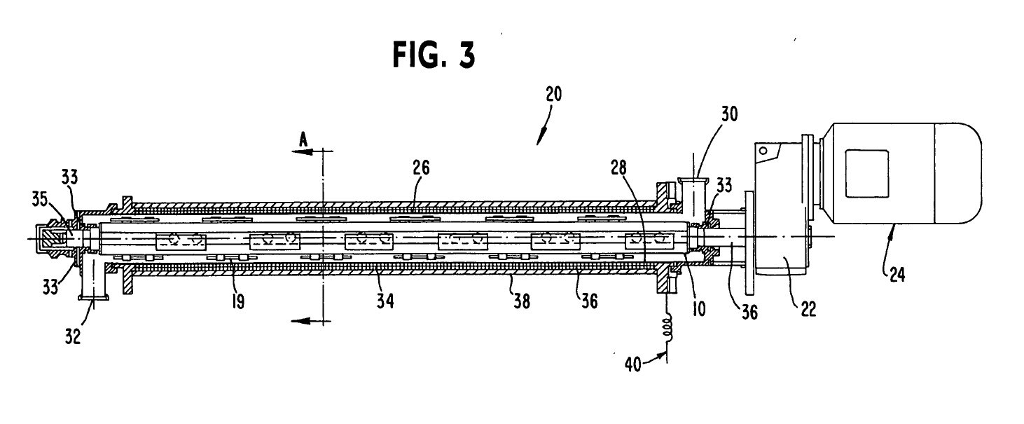

FIG. 3 depicts an assembled scraped surface heat exchanger assembly 20 which may contain a mutator shaft 10 as depicted, for example, in FIG. 1. The mutator shaft 10 is preferably assembled in direct connection with the drive gear assembly 22 and motor 24 in order to induce rotation of the mutator shaft 10. The embodiment depicted in FIG. 3 illustrates the mutator shaft 10 inserted within a product tube 26 further assembled within the scraped surface heat exchanger assembly 20. A preferred embodiment comprises a configuration in which a plurality of scraper blades 19 are positioned and retained along the outside surface 18 of the mutator shaft 10 via scraper blade mounting pins 16. In full assembly, the scraper blades 19 serve to scrape the product off an inner surface 28 of the product tube 26 during its passage through the scraped surface heat exchanger 20.

A design of the scraped surface heat exchanger assembly 20 may provide a means for receiving a product for heat treatment processing and further provide additional means for feeding the treated product from the scraped surface heat exchanger assembly 20. In one embodiment, the means for receiving and feeding the product may include a first product connection 30 and a second product connection 32 coupled to the scraped surface heat exchanger assembly 20. The first product connection 30 and the second product connection 32 will provide the means by which the product is delivered to and received from the scraped surface heat exchanger assembly 20.

Each product connection 30, 32 is preferably sealed in relation to the product tube 26 to facilitate an aseptic processing environment. Such sealing may be accomplished using a shaft seal rings 33 which can be inserted, for example, ends 35, 36 of the mutator shaft 10. Materials for the shaft seal rings 33 may include elastomers designed for use in sanitary conditions. Such elastomers may included, for example, floral elastomers such as Viton® manufactured by Dupont. Alternatively the sealing rings may comprise other composite materials such as EPDM. Such materials are conducive to providing a sanitary working environment particularly suitable for use in the foodstuff industry.

In accordance with a preferred embodiment of the invention, an induction heating system comprising an induction heating blanket 34 is substantially wrapped around a longitudinal length of the product tube 26. A main function of the induction heating system includes providing transferred heat to the product tube 26 for heating the product therein. The aforementioned induction heating system essentially replaces the mediajacket and any associated media connections and/or additional equipment including, for example, boiler equipment as sometimes utilized in the prior art. The result of which can provide significant advantages over other industrial heating systems known in the prior art such as those utilizing a media jacket set-up.

A preferred embodiment of the induction heating system further comprises a power source 40, such as an AC power supply, and a plurality of induction heating coils 36. The design of the present invention utilizes the power supply 40 to send alternating current through the plurality of induction heating coils 36 to thereby generate a magnetic field around the product tube 26. Thus, eddy currents are induced within the product tube 26 to generate relatively precise amounts of clean, localized heat.

A protective cover 38 may enclose the induction blanket 34 to serve a variety of purposes including, for examples, sealing the induction blanket 34, providing an aesthetically pleasing finish as an exterior surface of the scraped surface heat exchanger assembly 20, and providing additional protection to the product tube 26. Preferred use of materials for constructing the protective cover 38 include acrylic or plastic. FIG. 4 depicts a cross-section of the scraped surface heat exchanger assembly 20 illustrating the induction blanket 34 within the protective cover 38 and further wrapped around a circumference of the product tube 26.

Advantages of using an induction heating system to heat a scraped surface heat exchanger assembly 20, as described herein, include an ability to generate consistent heating patterns for a given set-up. This may include operating through a series of multiple sequential heating cycles and performing on a daily basis. Hence, the reliability of the scraped surface heat exchanger assembly 20 and the ability to generate a quality treated product may increase and/or become more dependable.

The induction heating system is also capable of developing heat more directly and instantly (>2000° F. in <1 second) inside the product tube 26 which may further allow for quicker startup times for performing heat treatment operations than other industrial heating systems (such as equipment set-ups utilizing media jackets and associated equipment). Since heating process times can be dramatically reduced by the induction heating system of the present invention can be integrated directly into the production line, and production throughput can also be significantly increased.

The properties of the induction heating design may also lend itself to more controlled and directional heating. The aforementioned is further supported by the fact that the power input may be precisely controlled to achieve a precise temperature required for slow or fast heating. The flexibility of utilizing the induction heating system, as described herein, is further indicative of the fact that the induction coils may be located a distance away from the power supply. Hence, usage of the induction heating system in combination with the scraped surface heat exchanger assembly 20 of the present invention may provide greater alternatives to shop-floor set-ups and arrangements of scraped surface heat exchanger assemblies 20.

A further and inherent advantage of induction heating includes the benefits of providing a clean, non-polluting process. Induction heating generally produces no harmful emissions, exhaust gases, smoke, loud noise or waste heat to alter the surrounding environment. Thus, working conditions may be improved with the absence of smoke, fumes, noise and extraneous heat produced by furnaces or other industrial heating systems. Furthermore, the induction heating provided by the induction blanket 34 can be regarded as an energy-efficient process which can, in some instances, convert up to 90% of the energy expended into useful heat to reduce utility costs. Additionally, stand-by losses are reduced to a minimum because the heat is only “on” when actually performing its intended task.

Because of good and, in some cases, improved heat transfer properties provided by the induction blanket 34 design of the present invention may, a concern for the heat transfer capabilities of the product tube 26 can be reduced as would otherwise be required using a media jacket, for example. An inherent property of the induction heating design includes inducing heat directly into the product tube 26 itself. Hence, significant cost reduction may be realized by constructing the product tube 26 of less expensive materials which do not need to characterized as good heat transfer capabilities previously utilized in the prior art such as Nickel. Alternatively, materials such as stainless steel, may be utilized in the induction heating design of the present invention—a material of which is significantly less expensive yet suitable for constructing product tubes 26 of the present design. Additionally, since the induction heating design eliminates outside heating mediums under pressure, a concern for crushing the product tube 26 under such pressure is also eliminated. Thus, the product tube 26, may be made thinner to reduce additional costs in its construction thereof. Other cost benefits of the induction heating design may include eliminating additional sealings and fittings otherwise required in a design, for example, retrofitted with media connections and additional equipment for heating and delivering the media.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A scraped surface heat exchanger assembly comprising:
a product tube;
a mutator shaft inserted with the product tube;
an induction blanket disposed around a longitudinal length of the product tube;
a product feed inlet assembled to feed a product to the product tube; and
a product return outlet assembled to feed a product from the product tube.

2. The assembly of claim 1, further comprising:
a plurality of scraper blade mounting pins mounted along an outside surface of the mutator shaft.

3. The assembly of claim 2, further comprising:
a plurality of scraper blades retained by the scraper blade mounting pins.

4. The assembly of claim 1, further comprising:
a protective cover encasing the induction blanket.

5. The assembly of claim 4, further comprising:
an electrical connection coupled to the induction blanket to provide power.

6. The assembly of claim 5, wherein the protective cover seals the induction blanket to the scraped surface heat exchanger assembly.

7. The assembly of claim 6, wherein the protective cover is made from acrylic and/or plastic material.

8. The assembly of claim 1, further comprising:
a drive gear assembly and motor connected to the mutator shaft to provide rotation thereof.

9. The assembly of claim 8, further comprising:
splines located on an end of the mutator shaft and connected to the drive gear assembly.

10. A method of heating products in a scraped surface heat exchanger assembly comprising:
providing a product tube having an inner surface;
assembling a mutator shaft within the inner surface of the product tube;
feeding a product through the product tube; and
heating the product via an induction blanket disposed around a longitudinal length of the product tube as the product is fed through the product tube.

11. The method of claim 10, wherein the mutator shaft comprises a plurality of scraper blade mounting pins mounted along an outside surface of the mutator shaft and a plurality of scraper blades retained by the scraper blade mounting pins.

12. The method of claim 11, further comprising:
rotating the mutator shaft within the product tube.

13. The method of claim 12, further comprising:
scraping the inner surface of the product tube with the scraper blades.

14. A system for heating products in a scraped surface heat exchanger assembly comprising:
means for containing a product having an interior cavity;
means for rotating a product located within the interior cavity of the containing means;
means for providing heat via induction, configured around a longitudinal length of the containing means; and
means for feeding a product to the containing means.

15. The system of claim 14, further comprising:
means for encasing the induction heat means.

16. The system of claim 14, wherein the containing means comprises a product tube.

17. The system of claim 14, wherein the rotating means comprises a mutator shaft.

18. The system of claim 14, wherein the heat providing means comprises an induction blanket.

19. The system of claim 14, wherein the feeding means comprises a product feed connection.

20. The system of claim 15, wherein the encasing means comprises a protective cover.

21. The system of claim 20, wherein the protective cover seals the induction heat providing means to the scraped surface heat exchanger assembly.
